(19) United States
(12) Patent Application Publication
(10) Pub. No.: US 2015/0359079 A1
(43) Pub. Date: Dec. 10, 2015

(54) Etching Apparatus Using Inductively Coupled Plasma

(71) Applicant: SAMSUNG ELECTRONICS CO., LTD., SUWON-SI (KR)

(72) Inventor: Jong-Woo Sun, Seoul (KR)

(21) Appl. No.: 14/598,313

(22) Filed: Jan. 16, 2015

(30) Foreign Application Priority Data
Jun. 9, 2014 (KR) 10-2014-0069155

(51) Int. Cl. H05H 1/00

(52) U.S. Cl. CPC H05H 1/00

(57) ABSTRACT

An etching apparatus may include a chuck, an antenna and a dielectric window. A substrate may be placed on an upper surface of the chuck. The antenna may be arranged over the chuck to form an inductive electromagnetic field between the antenna and the chuck. The dielectric window may be arranged between the antenna and the chuck to transmit the inductive electromagnetic field to the substrate. The dielectric window may have at least two receiving spaces into which an etching gas may be introduced, and a plurality of injecting holes connected to the receiving spaces to inject the etching gas toward the substrate. Thus, the flux or flow rate of the etching gas supplied to the substrate may be selectively controlled.

### CROSS-RELATED APPLICATION

This application claims priority under 35 USC §119 to Korean Patent Application No. 10-2014-0069155, filed on Jun. 9, 2014, the contents of which are hereby incorporated herein by reference in their entirety.

### BACKGROUND

Generally, a plasma etching apparatus may use a capacitively coupled plasma (CCP) or an inductively coupled plasma (ICP).

The etching apparatus using the CCP may generate plasma from an etching gas, which may be injected from a dielectric window, using an RF electric field formed by applying RF power to chucks.

The etching apparatus using the ICP may generate plasma from an etching gas, which may be injected from a gas nozzle, using an electric field inducted by a coil antenna. RF power applied to the coil antenna may be transmitted to the etching gas through a dielectric plate.

According to related arts, the gas nozzle may be fixed to an etching chamber. However, the etching gas may not be uniformly supplied to a semiconductor substrate. Particularly, it may be difficult to control a flux or flow rate of the etching gas supplied to a desired region of the semiconductor substrate. When a distance between the gas nozzle and the semiconductor substrate may have to be long to uniformly supply the etching gas to the semiconductor substrate, the etching chamber may have a large size.

### SUMMARY

Example embodiments relate to an etching apparatus using inductively coupled plasma (ICP). More particularly, example embodiments relate to an etching apparatus configured to etch a layer on a semiconductor substrate using an ICP.

Example embodiments provide an etching apparatus using an ICP that may be capable of controlling a flux or flow rate of an etching gas.

According to some example embodiments, there may be provided an etching apparatus using an ICP. The etching apparatus may include a chuck, an antenna and a dielectric window. A substrate may be placed on an upper surface of the chuck. The antenna may be arranged over the chuck to form an inductive electromagnetic field between the antenna and the chuck. The dielectric window may be arranged between the antenna and the chuck to transmit the inductive electromagnetic field to the substrate. The dielectric window may have at least two receiving spaces into which an etching gas may be introduced, and a plurality of injecting holes connected to the receiving spaces to inject the etching gas toward the substrate.

In example embodiments, the receiving spaces may be isolated or spaced apart from each other.

In example embodiments, the receiving spaces may include at least one first receiving space arranged at a central portion of the dielectric window, and at least one second receiving space arranged at an edge portion of the dielectric window.

In example embodiments, the dielectric window may include a first gas line connected to the first receiving space, and a second gas line connected to the second receiving space.

In example embodiments, the etching apparatus may further include a flow rate controller (FRC) for selectively controlling a flux or flow rate of the etching gas supplied to the first gas line and the second gas line.

In example embodiments, the receiving spaces may further include a third receiving space arranged between the central portion and the edge portion of the dielectric window. A third gas line may be connected to the third receiving space.

In example embodiments, the injecting holes may be spaced apart from each other by substantially the same distance or interval.

In example embodiments, the etching apparatus may further include a heater in the chuck.

In example embodiments, the dielectric window may include aluminum oxide.

In example embodiments, the etching apparatus may further include an etching chamber configured to receive the chuck and the plasma.

In example embodiments, the antenna may be arranged outside the etching chamber.

In example embodiments, the dielectric window may form an upper surface of the etching chamber.

According to some example embodiments, there may be provided an etching apparatus using an ICP. The etching apparatus may include an etching chamber, a chuck, an antenna, a dielectric window and an FRC. The chuck may be positioned in the etching chamber. A substrate may be placed on an upper surface of the chuck. The antenna may be arranged outside of the etching chamber to generate an inductive electromagnetic field between the antenna and the chuck. The dielectric window may be arranged between the antenna and the chuck to transmit the inductive electromagnetic field to the substrate. The dielectric window may form an upper surface of the etching chamber. The dielectric window may have at least two receiving spaces into which an etching gas may be introduced, and a plurality of injecting holes connected to or in fluid communication with the receiving spaces to inject the etching gas toward the substrate. The FRC may be in fluid communication with the receiving spaces and may be configured to selectively control a flux or flow rate of the etching gas supplied to the receiving spaces.

In example embodiments, the receiving spaces may be isolated or spaced apart from each other.

In example embodiments, the receiving spaces may include at least one first receiving space arranged at a central portion of the dielectric window, and at least one second receiving space arranged at an edge portion of the dielectric window.

In example embodiments, the dielectric window may include a first gas line connected to the first receiving space, and a second gas line connected to the second receiving space.

In example embodiments, the receiving spaces may further include a third receiving space arranged between the central portion and the edge portion of the dielectric window. A third gas line may be connected to the third receiving space.

In example embodiments, the injecting holes may be spaced apart from each other by substantially the same distance or interval.

In example embodiments, the etching apparatus may further include a heater in the chuck.

In example embodiments, the dielectric window may include aluminum oxide.

According to some example embodiments, there may be provided an etching apparatus using ICP. The apparatus may include: an etching chamber; a chuck arranged in the etching chamber, with the chuck configured to support a substrate; an antenna arranged outside the etching chamber and configured to generate an electromagnetic field between the chuck and the antenna; a dielectric window arranged between the antenna and the chuck to transmit the electromagnetic field to the substrate; and a flow rate controller (FRC). The dielectric window may include: a central receiving cavity and a peripheral receiving cavity with each configured to receive an etching gas; a plurality of central injecting passageways in fluid communication with the central receiving cavity and configured to inject the etching gas to a central portion of the chamber; and a plurality of peripheral injecting passageways in fluid communication with the outer receiving cavity and configured to inject the etching gas to a peripheral portion of the chamber. The FRC may be in fluid communication with the central and peripheral receiving cavities. The FRC may be configured to: selectively control a flow rate of the etching gas supplied to the central receiving cavity to selectively control an amount of plasma generated in the central portion of the chamber; and selectively control a flow rate of the etching gas supplied to the peripheral receiving cavity to selectively control an amount of plasma generated in the peripheral portion of the chamber.

In example embodiments, the dielectric window may include: an intermediate receiving cavity configured to receive an etching gas and disposed between the central receiving cavity and the peripheral receiving cavity; and a plurality of intermediate injecting passageways in fluid communication with the intermediate receiving cavity and configured to inject the etching gas to an intermediate portion of the chamber.

In example embodiments, the intermediate receiving cavity may be annular and surround the central receiving cavity, and the peripheral receiving cavity may be annular and surround the intermediate receiving cavity.

In example embodiments, the intermediate receiving cavity may be spaced apart from the central receiving cavity, and the peripheral receiving cavity may be spaced apart from the intermediate receiving cavity.

In example embodiments, the FRC may be configured to selectively control a flow rate of the etching gas supplied to the intermediate receiving cavity to selectively control an amount of plasma generated in the intermediate portion of the chamber.

According to example embodiments, the dielectric window for transmitting the RF power of the antenna to the etching gas in the etching apparatus using the ICP may include the receiving spaces configured to receive the etching gas, and the injecting holes configured to inject the etching gas. Thus, the flux or flow rate of the etching gas supplied to the substrate may be selectively controlled. As a result, uniformity of the plasma applied to the substrate may be improved. Further, an amount of the plasma applied to the substrate may be determined by controlling the flux or flow rate of the etching gas supplied to the receiving spaces. Therefore, an etching control of the plasma to regions of the substrate may be improved.

### BRIEF DESCRIPTION OF THE DRAWINGS

Example embodiments will be more clearly understood from the following detailed description taken in conjunction with the accompanying drawings. FIGS. 1 to 5 represent non-limiting, example embodiments as described herein.

FIG. 1 is a cross-sectional view illustrating an etching apparatus using inductively coupled plasma (ICP) in accordance with example embodiments;

FIG. 2 is an enlarged perspective view illustrating a dielectric window of the etching apparatus in FIG. 1;

FIG. 3 is a cross-sectional view taken along the line in FIG. 2;

FIG. 4 is a cross-sectional view illustrating an etching apparatus using an ICP in accordance with example embodiments; and

FIG. 5 is a cross-sectional view illustrating a dielectric window of the etching apparatus in FIG. 4.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of components, layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

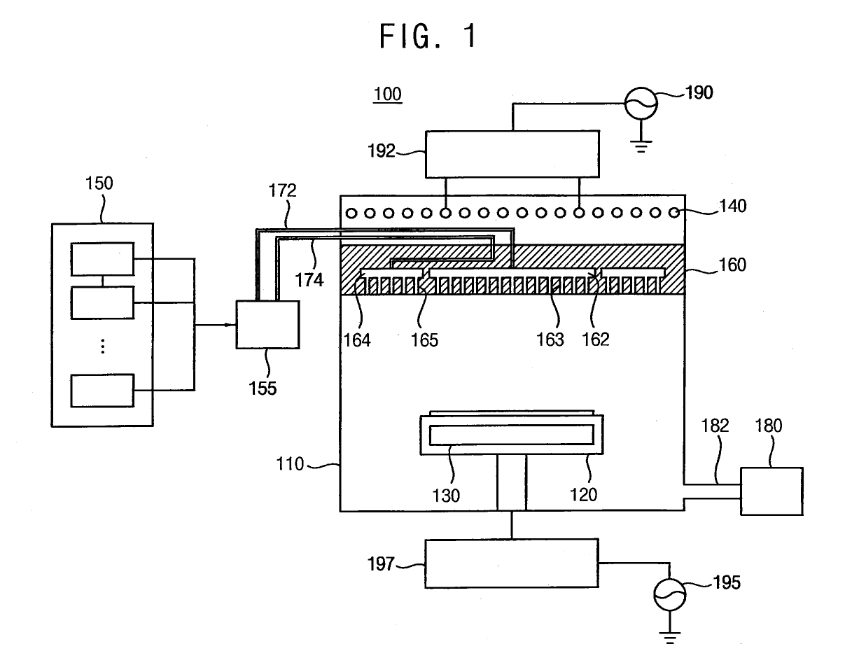

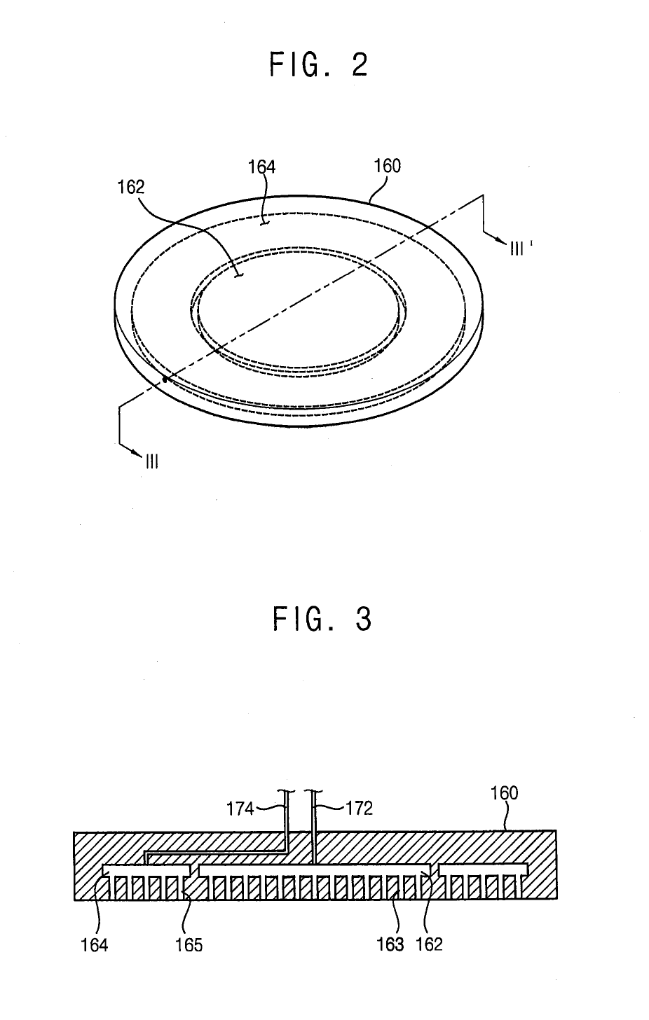

FIG. 1 is a cross-sectional view illustrating an etching apparatus using an inductively coupled plasma (ICP) in accordance with example embodiments, FIG. 2 is an enlarged perspective view illustrating a dielectric window of the etching apparatus in FIG. 1, and FIG. 3 is a cross-sectional view taken along a line in FIG. 2.

Referring to FIG. 1, an etching apparatus 100 using an ICP in accordance with this example embodiment may include an etching chamber 110, a chuck 120, a heater 130, an antenna 140, an etching gas tank 150, a flow rate controller (FRC) 155, a dielectric window 160 and an exhaust pump 180.

In example embodiments, the etching apparatus 100 may etch a layer on a substrate using the ICP. Thus, the etching gas tank 150 may be configured to store an etching gas. The substrate may include a semiconductor substrate, a glass substrate, etc.

The exhaust pump 180 may be connected to the etching chamber 110 through an exhaust line 182. The exhaust pump 180 may exhaust byproducts generated in the etching chamber 110.

The chuck 120 may be arranged on or at a bottom surface or bottom portion of the etching chamber 110. The chuck 120 may be configured to support the semiconductor substrate. Thus, the semiconductor substrate may be placed on an upper surface of the chuck 120. The chuck 120 may be electrically connected with an RF power source 195 through a matcher 197. Additionally, the heater 130 configured to heat the semiconductor substrate may be arranged in or on the chuck 120. In example embodiments, the chuck 120 may be or include an electrostatic chuck (ESC).

The antenna 140 may be arranged on an upper surface of the etching chamber 110. The antenna 140 may be electrically connected with an RF power source 190 through a matcher 192. An electromagnetic field induced by the antenna 140 may be applied to the etching gas injected into the etching chamber 110 to generate plasma. In example embodiments, the antenna 140 may have a coil shape.

The dielectric window 160 may be arranged on a lower surface of the antenna 140 to define the upper surface of the etching chamber 110. Thus, the antenna 140 may be positioned outside the etching chamber 110. The dielectric window 160 may include a dielectric material. For example, the dielectric window 160 may include aluminum oxide (Al₂O₃). The dielectric window 160 may function as to transfer the RF power in the antenna 140 into the etching chamber 110.

Further, the dielectric window 160 may also function to inject the etching gas into the etching chamber 110. That is, the dielectric window 160 may function as a dielectric window in substrate-processing apparatuses. Thus, the etching apparatus 100 using the ICP may not include a gas nozzle configured to inject the etching gas into the etching chamber 110.

Referring to FIGS. 2 and 3, the dielectric window 160 may have a circular plate shape. The dielectric window 160 may include a first receiving space or cavity 162, a second receiving space or cavity 164, first injecting holes or passageways 163, second injecting holes or passageways 165, a first gas line 172 and a second gas line 174.

The first receiving space 162 may be formed at a central portion of the dielectric window 160. The first receiving space 162 may have a circular shape. The second receiving space 164 may be formed at an edge or peripheral portion of the dielectric window 160. The second receiving space 164 may have an annular shape configured to surround the first receiving space 162. The first receiving space 162 may be isolated or spaced apart from the second receiving space 164. An amount of the etching gas injected to the central portion of the etching chamber 110 and an amount of the etching gas injected to the edge or peripheral portion of the etching chamber 110 may be controlled by adjusting volumes of the first receiving space 162 and the second receiving space 164. Therefore, an amount of the plasma generated in the central portion of the etching chamber 110 and an amount of the plasma generated in the edge portion of the etching chamber 110 may be selectively controlled.

The first gas line 172 may be connected to the first receiving space 162. The second gas line 174 may be connected to the second receiving space 164. The first gas line 172 and the second gas line 174 may be connected to the etching gas tank 150 (FIG. 1). The etching gas tank 150 may be configured to store one or more kinds or types of etching gas. Thus, one kind of the etching gas or at least two kinds of the etching gases may be selectively supplied to the first gas line 172 and the second gas line 174.

The FRC 155 (FIG. 1) may be installed at the first gas line 172 and the second gas line 174 or may be in fluid communication with each of the first and second gas lines 172, 174. The FRC 155 may selectively control a flux or flow rate of the etching gas supplied to the first receiving space 162 through the first gas line 172 and a flux or flow rate of the etching gas supplied to the second receiving space 164 through the second gas line 174. Thus, an amount of the etching gas injected to the central portion of the etching chamber 110 and an amount of the etching gas injected to the edge or peripheral portion of the etching chamber 110 may be selectively controlled by adjusting the fluxes of the etching gas supplied to the first receiving space 162 and the second receiving space 164. As a result, the amount of the plasma generated in the central portion of the etching chamber 110 and the amount of the plasma generated in the edge portion of the etching chamber 110 may be selectively controlled.

The first injecting holes 163 may be arranged on a central portion of a lower surface of the dielectric window 160. The first injecting holes 163 may be connected to or be in fluid communication with the first receiving space 162. Thus, the etching gas introduced into the first receiving space 162 may be injected into the etching chamber 110 through the first injecting holes 163. In order to uniformly distribute the etching gas in the central portion of the etching chamber 110, the first injecting holes 163 may be spaced apart from each other by substantially the same distance or interval.

The second injecting holes 165 may be arranged on an edge portion of the lower surface of the dielectric window 160. The second injecting holes 165 may be connected to or be in fluid communication with the second receiving space 164. Thus, the etching gas introduced into the second receiving space 164 may be injected into the etching chamber 110 through the second injecting holes 165. In order to uniformly distribute the etching gas in the edge or peripheral portion of the etching chamber 110, the second injecting holes 165 may be spaced apart from each other by substantially the same distance or interval.

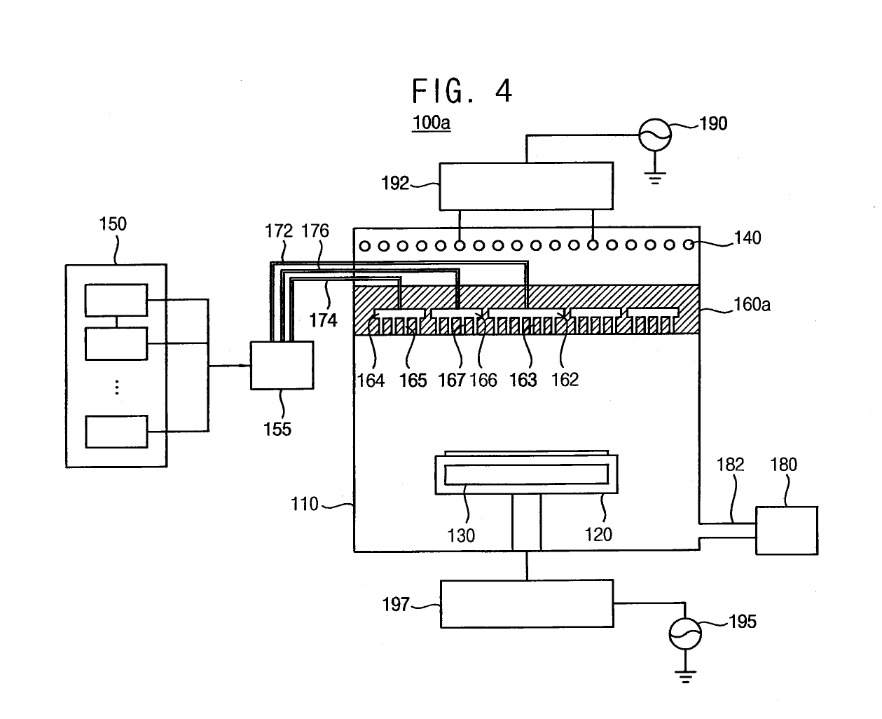

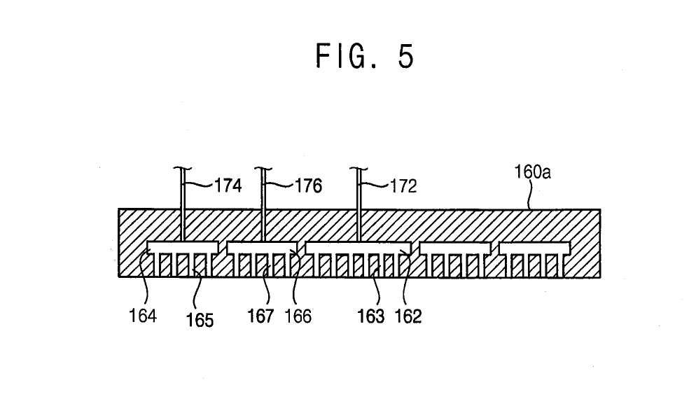

FIG. 4 is a cross-sectional view illustrating an etching apparatus using an ICP in accordance with example embodiments, and FIG. 5 is a cross-sectional view illustrating a dielectric window of the etching apparatus in FIG. 4.

An etching apparatus 100a using an ICP in accordance with this example embodiment may include elements substantially the same as those of the etching apparatus 100 in FIG. 1 except for the dielectric window. Thus, the same reference numerals may refer to the same elements and any further description with respect to the same elements may be omitted herein for brevity.

Referring to FIGS. 4 and 5, the dielectric window 160a may include a first receiving space or cavity 162, a second receiving space or cavity 164, a third receiving space or cavity 166, first injecting holes or passageways 163, second injecting holes or passageways 165, third injecting holes or passageways 167, a first gas line 172, a second gas line 174 and a third gas line 175.

The first receiving space 162 may be formed at a central portion of the dielectric window 160a. The first receiving space 162 may have a circular shape. The second receiving space 164 may be formed at an edge or peripheral portion of the dielectric window 160a. The second receiving space 164 may have an annular shape. The third receiving space 166 may have an annular shape formed at an intermediate portion of the dielectric window 160a between the first receiving space 162 and the second receiving space 164. The first receiving space 162, the second receiving space 164 and the third receiving space 166 may be isolated or spaced apart from each other. An amount of the etching gas injected to the central portion of the etching chamber 110, an amount of the etching gas injected to the edge or peripheral portion of the etching chamber 110 and an amount of the etching gas injected to the intermediate or middle portion of the etching chamber 110 may be controlled by adjusting volumes of the first receiving space 162, the second receiving space 164 and the third receiving space 166. The intermediate portion of the etching chamber 110 may be between the central and peripheral portions of the etching chamber 110.

The first gas line 172 may be connected to the first receiving space 162. The second gas line 174 may be connected to the second receiving space 164. The third gas line 176 may be connected to the third receiving space 166. The first gas line 172, the second gas line 174 and the third gas line 176 may be connected to or be in fluid communication with the etching gas tank 150. The etching gas tank 150 may be configured to store one or more kinds or types of etching gas. Thus, one kind of the etching gas or at least two kinds of the etching gases may be selectively supplied to the first gas line 172, the second gas line 174 and the third gas line 176.

The FRC 155 may be installed at or may be in fluid communication with the first gas line 172, the second gas line 174 and the third gas line 176. The FRC 155 may selectively control a flux or flow rate of the etching gas supplied to the first receiving space 162 through the first gas line 172, a flux or flow rate of the etching gas supplied to the second receiving space 164 through the second gas line 174 and a flux or flow rate of the etching gas supplied to the third receiving space 166 through the third gas line 176. Thus, an amount of the etching gas injected to the central portion of the etching chamber 110, an amount of the etching gas injected to the edge or peripheral portion of the etching chamber 110 and an amount of the etching gas injected to the intermediate or middle portion of the etching chamber 110 may be selectively controlled by adjusting the fluxes of the etching gas supplied to the first receiving space 162, the second receiving space 164 and the third receiving space 166. As a result, the amount of the plasma generated in the central portion of the etching chamber 110, the amount of the plasma generated in the edge or peripheral portion of the etching chamber 110 and the amount of the plasma generated in the intermediate or middle portion of the etching chamber 110 may be selectively controlled.

The first injecting holes 163 may be arranged on a central portion of a lower surface of the dielectric window 160a. The first injecting holes 163 may be connected to or be in fluid communication with the first receiving space 162. Thus, the etching gas introduced into the first receiving space 162 may be injected into the etching chamber 110 through the first injecting holes 163. In order to uniformly distribute the etching gas in the central portion of the etching chamber 110, the first injecting holes 163 may be spaced apart from each other by substantially the same distance or interval.

The second injecting holes 165 may be arranged on an edge or peripheral portion of the lower surface of the dielectric window 160a. The second injecting holes 165 may be connected to or be in fluid communication with the second receiving space 164. Thus, the etching gas introduced into the second receiving space 164 may be injected into the etching chamber 110 through the second injecting holes 165. In order to uniformly distribute the etching gas in the edge or peripheral portion of the etching chamber 110, the second injecting holes 165 may be spaced apart from each other by substantially the same distance or interval.

The third injecting holes 167 may be arranged on an intermediate or middle portion of the lower surface of the dielectric window 160a. The third injecting holes 167 may be connected to or be in fluid communication with the third receiving space 166. Thus, the etching gas introduced into the third receiving space 166 may be injected into the etching chamber 110 through the third injecting holes 167. In order to uniformly distribute the etching gas in the intermediate or middle portion of the etching chamber 110, the third injecting holes 167 may be spaced apart from each other by substantially the same distance or interval.

In example embodiments, the dielectric window may include the three receiving spaces. Alternatively, the dielectric window may include at least four receiving spaces.

According to example embodiments, the dielectric window for transmitting the RF power of the antenna to the etching gas in the etching apparatus using the ICP may include the receiving spaces configured to receive the etching gas, and the injecting holes configured to inject the etching gas. Thus, the flux or flow rate of the etching gas supplied to the substrate may be selectively controlled. As a result, uniformity of the plasma applied to the substrate may be improved. Further, an amount of the plasma applied to the substrate may be determined by controlling the flux or flow rate of the etching gas supplied to the receiving spaces. Therefore, improved etching control of the plasma to regions of the substrate may be achieved.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims.

What is claimed is:

1. An etching apparatus using inductively coupled plasma (ICP), the etching apparatus comprising:
a chuck on which a substrate is placed;
an antenna arranged over the chuck and configured to form an electromagnetic field between the chuck and the antenna; and
a dielectric window arranged between the antenna and the chuck to transmit the electromagnetic field to the substrate, the dielectric window including at least two receiving spaces and a plurality of the injecting holes associated with each receiving space, the receiving spaces configured to receive an etching gas from which the ICP is generated, the injecting holes in fluid communication with the receiving spaces and configured to inject the etching gas to the substrate.

2. The etching apparatus of claim 1, wherein the receiving spaces are spaced apart from each other.

3. The etching apparatus of claim 1, wherein the receiving spaces comprise:
at least one first receiving space arranged at a central portion of the dielectric window; and
at least one second receiving space arranged at an edge portion of the dielectric window.

4. The etching apparatus of claim 3, further comprising:
a first gas line connected to the first receiving space of the dielectric window; and
a second gas line connected to the second receiving space of the dielectric window.

5. The etching apparatus of claim 4, further comprising a flow rate controller (FRC) configured to selectively control a flow rate of the etching gas supplied to the first gas line and the second gas line.

6. The etching apparatus of claim 3, wherein the receiving spaces further comprise a third receiving space formed between the central portion and the edge portion of the dielectric window, and a third gas line is connected to the third receiving space.

7. The etching apparatus of claim 1, wherein the injecting holes are spaced apart from each other by substantially the same distance.

8. The etching apparatus of claim 1, further comprising a heater arranged in the chuck.

9. The etching apparatus of claim 1, wherein the dielectric window comprises aluminum oxide.

10. The etching apparatus of claim 1, further comprising an etching chamber having a space in which the chuck is positioned and the plasma is generated.

11. The etching apparatus of claim 10, wherein the antenna is arranged outside the etching chamber.

12. The etching apparatus of claim 10, wherein the dielectric window forms an upper surface of the etching chamber.

13. An etching apparatus using inductively coupled plasma (ICP), the etching apparatus comprising:
an etching chamber;
a chuck arranged in the etching chamber, the chuck configured to support a substrate;
an antenna arranged outside the etching chamber and configured to generate an electromagnetic field between the chuck and the antenna;
a dielectric window arranged between the antenna and the chuck to transmit the electromagnetic field to the substrate and to form an upper surface of the etching chamber, the dielectric window including at least two receiving spaces and a plurality of the injecting holes in fluid communication with each receiving space, the receiving spaces configured to receive an etching gas from which the ICP is generated, the injecting holes configured to inject the etching gas to the substrate; and
a flow rate controller (FRC) configured to selectively control a flow rate of the etching gas supplied to the receiving spaces.

14. The etching apparatus of claim 13, wherein the receiving spaces comprise:
at least one first receiving space arranged at a central portion of the dielectric window; and
at least one second receiving space arranged at an edge portion of the dielectric window.

15. The etching apparatus of claim 14, further comprising:
a first gas line connected to the first receiving space of the dielectric window; and
a second gas line connected to the second receiving space of the dielectric window.

16. An etching apparatus using inductively coupled plasma (ICP), the etching apparatus comprising:
an etching chamber;
a chuck arranged in the etching chamber, the chuck configured to support a substrate;
an antenna arranged outside the etching chamber and configured to generate an electromagnetic field between the chuck and the antenna;
a dielectric window arranged between the antenna and the chuck to transmit the electromagnetic field to the substrate, the dielectric window comprising:
a central receiving cavity and a peripheral receiving cavity each configured to receive an etching gas;
a plurality of central injecting passageways in fluid communication with the central receiving cavity and configured to inject the etching gas to a central portion of the chamber; and
a plurality of peripheral injecting passageways in fluid communication with the peripheral receiving cavity and configured to inject the etching gas to a peripheral portion of the chamber; and
a flow rate controller (FRC) configured to:
selectively control a flow rate of the etching gas supplied to the central receiving cavity to selectively control an amount of plasma generated in the central portion of the chamber; and
selectively control a flow rate of the etching gas supplied to the peripheral receiving cavity to selectively control an amount of plasma generated in the peripheral portion of the chamber.

17. The etching apparatus of claim 16, wherein the dielectric window further comprises:
an intermediate receiving cavity configured to receive an etching gas and disposed between the central receiving cavity and the peripheral receiving cavity; and
a plurality of intermediate injecting passageways in fluid communication with the intermediate receiving cavity and configured to inject the etching gas to an intermediate portion of the chamber.

18. The etching apparatus of claim 17, wherein the intermediate receiving cavity is annular and surrounds the central receiving cavity, and wherein the peripheral receiving cavity is annular and surrounds the intermediate receiving cavity.

19. The etching apparatus of claim 18, wherein the intermediate receiving cavity is spaced apart from the central receiving cavity, and wherein the peripheral receiving cavity is spaced apart from the intermediate receiving cavity.

20. The etching apparatus of claim 17, wherein the FRC is configured to selectively control a flow rate of the etching gas supplied to the intermediate receiving cavity to selectively control an amount of plasma generated in the intermediate portion of the chamber.
